(19) United States
(12) Patent Application Publication
(10) Pub. No.: US 2014/0046494 A1
(43) Pub. Date: Feb. 13, 2014

(54) DYNAMIC SENSORS

(71) Applicant: MCALISTER TECHNOLOGIES, LLC, Phoenix, AZ (US)

(72) Inventor: Roy Edward McAlister, Phoenix, AZ (US)

(73) Assignee: MCALISTER TECHNOLOGIES, LLC, Phoenix, AZ (US)

(21) Appl. No.: 13/831,344

(22) Filed: Mar. 14, 2013

Related U.S. Application Data
(60) Provisional application No. 61/682,681, filed on Aug. 13, 2012.

(51) Int. Cl. G06F 1/26

(52) U.S. Cl. CPC G06F 1/26
USPC 700/287

(57) ABSTRACT

Dynamic sensors for sensing and adaptively controlling various events, operations and/or conditions in various systems including combustion engines and thermochemical regeneration systems are disclosed. A dynamic sensor includes one or more transducer components for detecting conditions and events and generating detected signals, a controller for receiving and processing detected signals to generate an output signal for controlling one or more conditions, a transceiver component that can be controlled using radio frequency, acoustic or other means, and that can report the output signal continuously, periodically or when interrogated, a memory for storing instructions, calibration data and/or measured data, and an energy harvester component that harvests energy from events to power one or more components of the dynamic sensor.

### CROSS-REFERENCE TO RELATED APPLICATION(S)

The present application claims priority to and benefit of U.S. Patent Application No. 61/682,681 titled “DYNAMIC SENSOR” filed on Aug. 13, 2012, which is incorporated by reference herein.

The present application is related to U.S. patent application Ser. No. 13/027,188, filed Feb. 14, 2011 (now U.S. Pat. No. 8,312,759, issued Nov. 20, 2012) and entitled “METHODS, DEVICES, AND SYSTEMS FOR DETECTING PROPERTIES OF TARGET SAMPLES” (Attorney Docket No. 69545.8801.US01); U.S. patent application Ser. No. 12/653,085, filed Dec. 7, 2009 and entitled “INTEGRATED FUEL “INTEGRATED FUEL INJECTORS AND IGNITERS AND ASSOCIATED METHODS OF USE AND MANUFACTURE” (Attorney Docket No. 69545-8304.US00); U.S. patent application Ser. No. 12/841,170, filed Jul. 21, 2010 and entitled “INTEGRATED FUEL INJECTORS AND IGNITERS AND ASSOCIATED METHODS OF USE AND MANUFACTURE” (Attorney Docket No. 69545-8305.US00); U.S. patent application Ser. No. 12/804,509, filed Jul. 21, 2010 and entitled “METHOD AND SYSTEM OF THERMOCHEMICAL REGENERATION TO PROVIDE OXYGENATED FUEL FOR EXAMPLE, WITH FUEL-COOLED INJECTORS” (Attorney Docket No. 69545-8310.US00); and U.S. patent application Ser. No. 12/707,651, filed Feb. 17, 2010 (now U.S. Pat. No. 8,075,748, issued Dec. 13, 2011) and entitled “ELECTROLYTIC CELL AND METHOD OF USE THEREOF” (Attorney Docket No. 69545-8101.US01). The aforementioned applications are incorporated herein by reference in their entirety.

### TECHNICAL FIELD

The present disclosure is directed generally to dynamic sensors for detecting and/or measuring events in combustion engines, thermochemical regeneration process apparatuses, heat pipe apparatus, and the like and providing adaptive control.

### BACKGROUND

Sensors and transducers are generally used to sense and/or measure external stimuli such as light, heat, sound, etc. Sensors and transducers are integrated in electrical devices for automation and control. For example, the carbon monoxide detector is a type of a transducer that is battery powered and detects carbon monoxide levels. When the carbon monoxide level is above a threshold, the detector sounds an alarm using a built-in speaker.

### BRIEF DESCRIPTION OF THE DRAWINGS

FIG. 1 is a block diagram of example components of a dynamic sensor in one embodiment.

FIG. 2 is a block diagram of an example process of a dynamic sensor in one embodiment.

FIG. 3 is a flow diagram illustrating an example method of sensing combustion events for adaptively controlling parameters to adjust combustion chamber conditions.

FIG. 4A is a cross-sectional schematic diagram of a pressure or temperature transducer 400 based on a Fabry mirror.

FIG. 4B is a cross-sectional schematic diagram of a portion of an injector.

FIG. 4C is cross-sectional diagram of a system for determining temperature and/or pressure of a combustion chamber.

FIG. 4D is a flow diagram illustrating an example method for determining and reporting pressure using a dynamic sensor in the system illustrated in FIG. 4C

FIG. 5A is a cross-sectional diagram of a system for determining the velocity of a piston inside a combustion chamber.

FIG. 5B is a schematic diagram illustrating detection of an acoustic signal using a dynamic sensor in the system illustrated in FIG. 5A.

FIG. 5C is a flow diagram illustrating a method for determining the velocity of a piston in the system illustrated in FIGS. 5A and 5B.

FIG. 6A is a cross-sectional side view of a Spark Injector or Smart Plug with RF shielding.

FIGS. 6B-6C are cross-sectional views of conductors having RF shielding in the Spark Injector or Smart Plug illustrated in FIG. 6A.

FIG. 7 is a schematic cross-sectional view of a Thermochemical Regeneration (TCR) system having one or more dynamic sensors.

FIG. 8 is a flow diagram illustrating a method of using a dynamic sensor in the TCR system illustrated in FIG. 7.

### DETAILED DESCRIPTION

The present disclosure describes a dynamic sensor, and methods, systems and associated components for detecting and/or measuring various events, conditions, properties and/or presence of target samples using the dynamic sensor. In certain embodiments, the dynamic sensor provides a “tattletale” or other type of feedback indication related to events and conditions associated with operation of various systems and/or properties, conditions, presence, and/or other characteristics of a target sample. In other embodiments, the dynamic sensor can control the sensed or other events and conditions based on the detected or measured events and conditions.

According to aspects of the disclosure, the dynamic sensor can include both passive and active functionality. In one aspect, a dynamic sensor receives and registers input events and harvests energy from the input events to do additional work. For example, the dynamic sensor can convert energy from pressure, radiation, vibration, thermal gradients, etc. to electrical energy that can be stored in capacitors and used to power the components of the dynamic sensor. In a further aspect, the dynamic sensor emits a tracer signal (e.g., light, acoustic wave, etc.) or an interrogation signal to establish a base line for sensing by other sensors. The dynamic sensor can be a part of an acoustic modifier device and can be remotely triggered to emit acoustic waves for shaping a working fluid, such as air, fuel, plasma, etc. The emitted acoustic waves can also trigger supercavitation or phase shift in fluids to, for example, stimulate fluid movement.

According to aspects of the disclosure, the dynamic sensor or a collection of dynamic sensor nodes (i.e., dynamic sensor network) can communicate with each other using radio frequency or other wireless and/or wired communication methods. The dynamic sensor can provide real-time data collection, correction, and/or reporting. The dynamic sensor can also use radio frequency or other wireless and wired communication methods to report signals to a controller for actuating components of the system (e.g., actuating an igniter/injector), a central command that can evaluate reporting from various dynamic sensor nodes in the network as a whole to take certain actions.

The dynamic sensor can be integrated with combustion engines, thermochemical regeneration process apparatuses, heat pipe apparatus, and the like for sensing and adaptively controlling various events, operations and/or conditions in such systems. For example, the dynamic sensor can sense and control the ionization within a combustion chamber, associated systems, assemblies, components, and methods. Furthermore, several of the embodiments described below are directed to adaptively controlling the ionization within a combustion chamber based on various conditions within the combustion chamber and/or based on various conditions at regions at or near an igniter/injector within the combustion chamber. Multiple dynamic sensors can be placed in certain locations to determine, for example, shape and penetration rate of a plasma injection, control timing of injection, and the like.

Certain details are set forth in the following description and in Figures to provide a thorough understanding of various embodiments of the disclosure. However, other details describing well-known structures and systems often associated with internal combustion engines, injectors, igniters, and/or other aspects of combustion systems are not set forth below to avoid unnecessarily obscuring the description of various embodiments of the disclosure. Thus, it will be appreciated that several of the details set forth below are provided to describe the following embodiments in a manner sufficient to enable a person skilled in the relevant art to make and use the disclosed embodiments. Several of the details and advantages described below, however, may not be necessary to practice certain embodiments of the disclosure.

Many of the details, dimensions, angles; shapes, and other features shown in the Figures are merely illustrative of particular embodiments of the disclosure. Accordingly, other embodiments can have other details, dimensions, angles, and features without departing from the spirit or scope of the present disclosure. In addition, those of ordinary skill in the art will appreciate that further embodiments of the disclosure can be practiced without several of the details described below.

Reference throughout this specification to “one embodiment” or “an embodiment” means that a particular feature, structure, or characteristic described in connection with the embodiment is included in at least one embodiment of the present disclosure. Thus, the occurrences of the phrases “in one embodiment” or “in an embodiment” in various places throughout this specification are not necessarily all referring to the same embodiment. Furthermore, the particular features, structures, or characteristics may be combined in any suitable manner in one or more embodiments. The headings provided herein are for convenience only and do not interpret the scope or meaning of the claimed disclosure.

### Example Structure and Process of a Dynamic Sensor

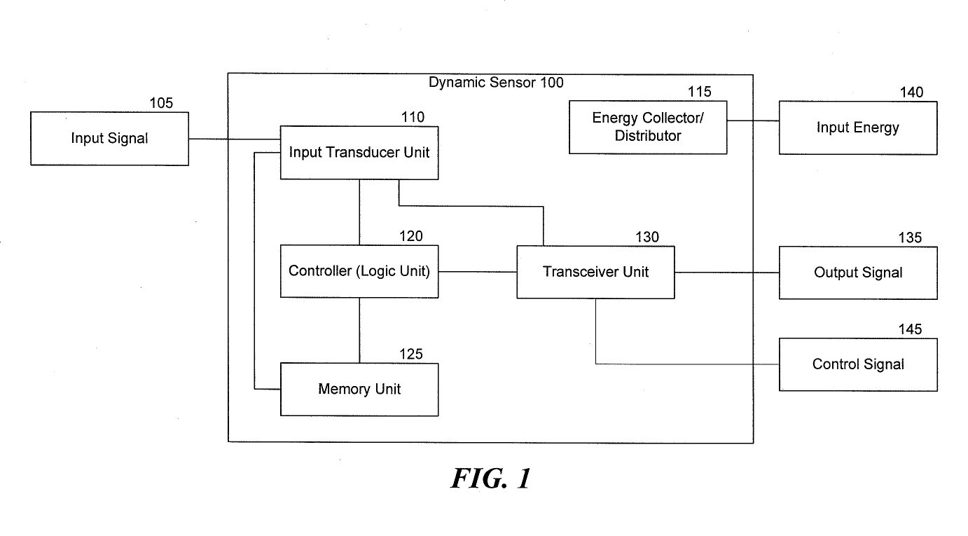

FIG. 1 is a block diagram of example components of a dynamic sensor 100 in one embodiment. Dynamic sensor 100 includes an input transducer unit 110, an energy collector/distributor 115, a controller or a logic unit 120, a memory unit 125, and a transceiver unit 130. The dynamic sensor 100 receives an input signal 105 and generates an output signal 135.

The input transducer unit 110 includes a sensing element, or an array of sensing elements and associated circuitry. The input transducer unit 110 may detect acoustic (e.g., wave, spectrum, wave velocity, etc.), electrical (charge, current, voltage, electric field, conductivity, resistivity, etc.), magnetic (e.g., magnetic field, magnetic flux, etc.), electromagnetic (e.g., light), optical (e.g., wave, wave velocity, refractive index, reflectivity, absorption, etc.), thermal (e.g. temperature, specific heat, thermal conductivity, etc.), mechanical (e.g., position, velocity, acceleration, force, stress, pressure, strain, mass, density, compliance, structure, orientation, vibration, etc.), chemical energy, and/or the like. In one embodiment, the dynamic sensor 100 may include multiple input transducer units 110. For example, one transducer unit may be used to detect and/or measure temperature, while another transducer unit may be used to detect and/or measure pressure. The multiple transducer units can be operational at the same time, or can be selectively turned on or off based on internal logic or external control signal 145.

The transceiver unit 130 includes receiver/transmitter (e.g., nano radio) for receiving and/or transmitting radio frequency signals between the components of the dynamic sensor 100, and between the dynamic sensor 100 and one or more components, including other dynamic sensor nodes external to the dynamic sensor 100. The transceiver unit 130, in one embodiment, may also receive a control signal 145 from other dynamic sensor nodes or controllers. The control signal 145 may be used to control various aspects of the operation of the dynamic sensor 100. For example, the control signal can be used to program the controller unit, provide a new baseline, reference, or other threshold parameter for storage in the memory unit 125, request reports on measured data, selectively turn on or off transducer units, turn on or off the dynamic sensor unit, and the like.

The controller or logic unit 120 processes one or more signals sensed or detected by the transducer unit 110 to determine and/or generate an output signal which is then transmitted to a component external to the dynamic sensor 100 using the transceiver unit 130. For example, the controller or logic unit 120 may compare detected signals from the transducer unit 110 with a base line signal, and determine whether or not to report the detected signals.

The memory unit 125 stores data relating to the detected signals, calibration data, and the like. The memory unit 125 is in communication with the input transducer unit 110, the controller or logic unit 120.

The energy collector or distributor 115 generates or harvests electrical energy from input energy 140, such as heat, light, vibration, acoustic and other energy in the environment, and uses the electrical energy to power one or more of the input transducer unit 110, the controller or logic unit 120, the memory unit 125 and the transceiver unit 130. The energy collector 115 may harvest energy from heat, light, acoustic and/or pressure generated from combustion, temperature difference from heat pipe apparatus, chemical reaction, vibration and the like. The energy collector or distributor 115 can be a photovoltaic system, a piezoelectric system, thermal gradient system, and the like. The energy collector or distributor 115 can also include an energy storage component such as a capacitor, charge collector, or a battery unit that can accumulate and store the energy for distribution when required.

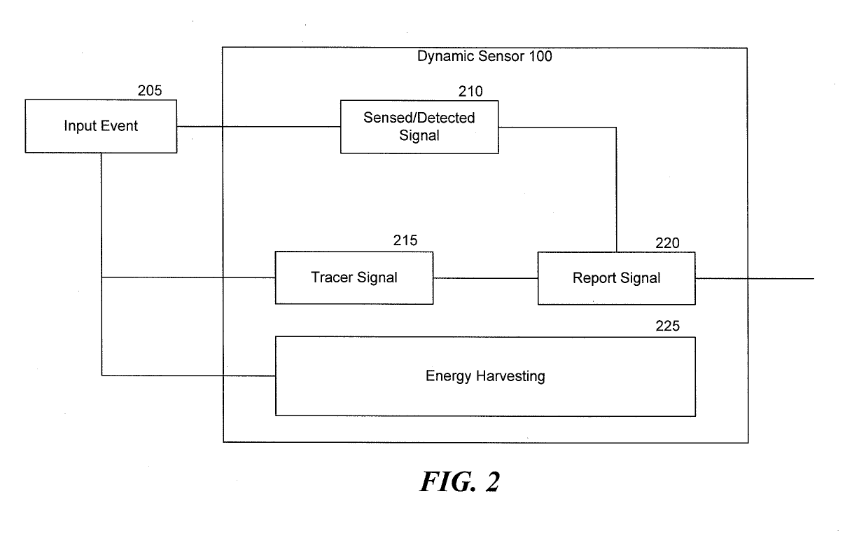

FIG. 2 is a block diagram of an example process of the dynamic sensor 100 in one embodiment. The dynamic sensor 100 receives an input event 205 and generates an sensed or detected signal 210. The dynamic sensor 100 also uses the input event 205 as a tracer signal 215 that can act as a reference or baseline signal, for example, for comparison with the sensed or detected signal 210. The sensed/detected signal 210 and tracer signal 215 may be compared and processed to generate a report signal 220 that is reported out to another component, such as a central controller, or other dynamic sensor nodes. Some dynamic sensors configured to detect certain chemicals, temperature, etc., may not need a reference, in which case, the tracer signal 215 would be an optional signal. In some instances, the report signal 220 can act as a control signal for other components of the system. For example, the report signal 220 can be used to control fuel injection into a combustion chamber of an engine under certain conditions. The energy harvesting process 225 can be used to harness energy from the pressure, temperature, vibration, radiation, etc., generated from the environment in which the dynamic sensor operates.

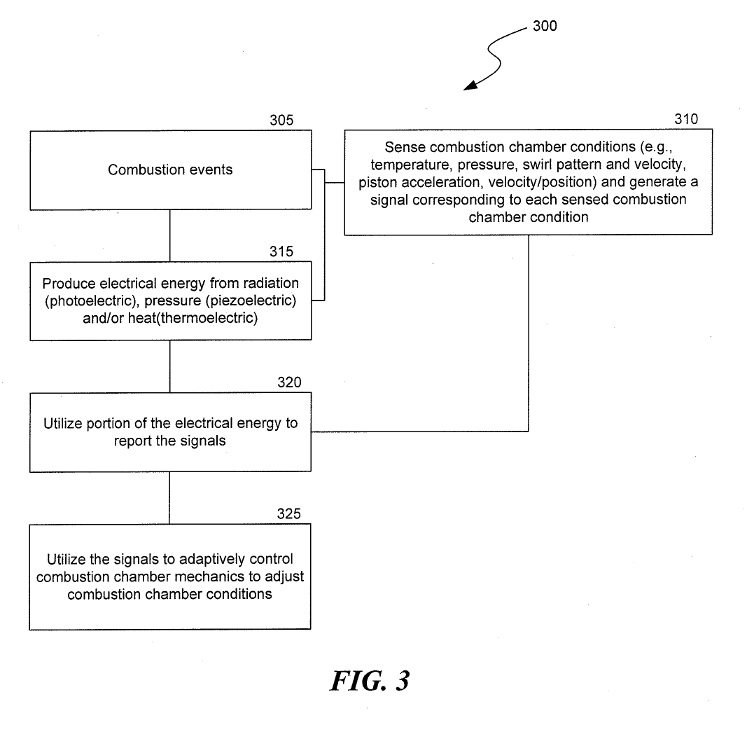

FIG. 3 is a flow diagram illustrating an example method of sensing combustion events for adaptively controlling parameters to adjust combustion chamber conditions. A dynamic sensor can measure various combustion events 305 that may generate radiation, pressure, heat, sound, and the like. At block 310, one or more dynamic sensors may sense combustion chamber conditions, such as temperature, pressure, swirl pattern and velocity, piston acceleration, velocity/position) and generate a signal corresponding to each sensed combustion chamber condition.

At block 315, the dynamic sensor can produce electrical energy from radiation (photoelectric), pressure (piezoelectric), and/or heat (thermoelectric) generated during combustion events. At block 320, a portion of the electrical energy is utilized to report the sensed or detected combustion chamber conditions. At block 325, the reported signal can be utilized to adaptively control combustion chamber mechanics to adjust combustion chamber conditions. For example, the reported signal can be used to vary the time of beginning fuel injection to a combustion chamber, time of plasma, time of end of fuel injection, time between fuel injections, magnitude of ultrasonic impetus, fuel injection pressure, etc.

### Example Transducer Elements of a Dynamic Sensor

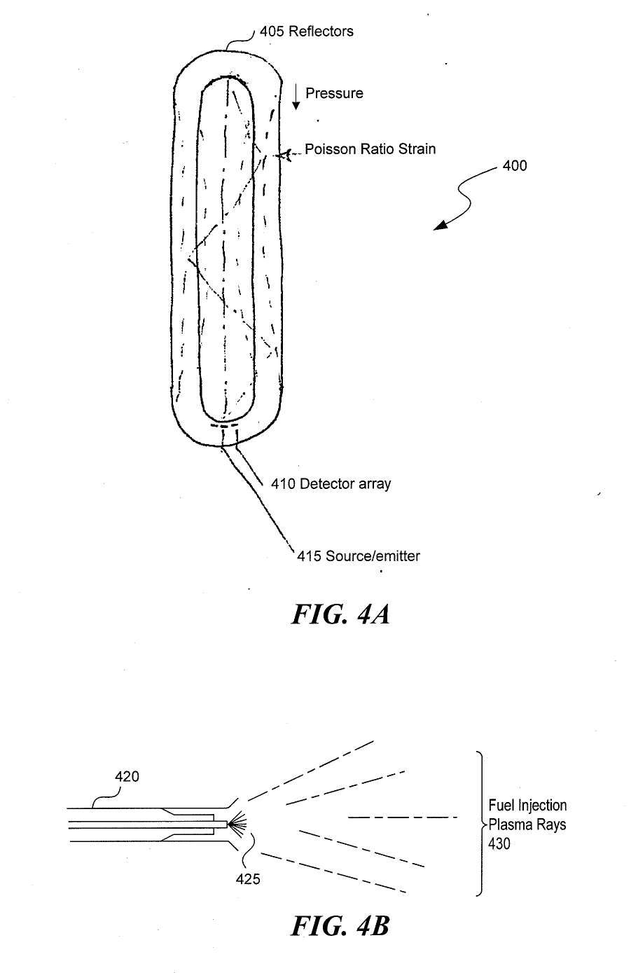

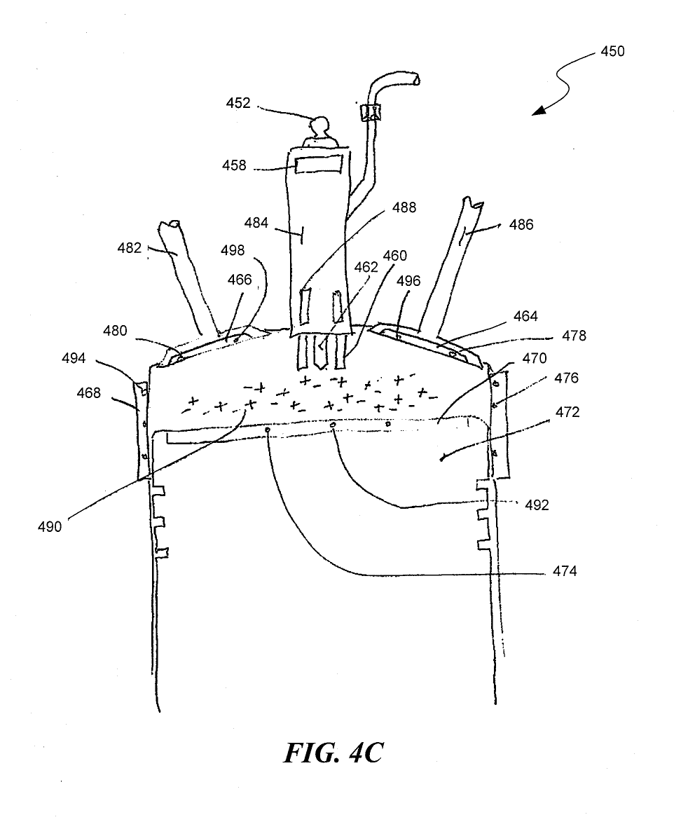

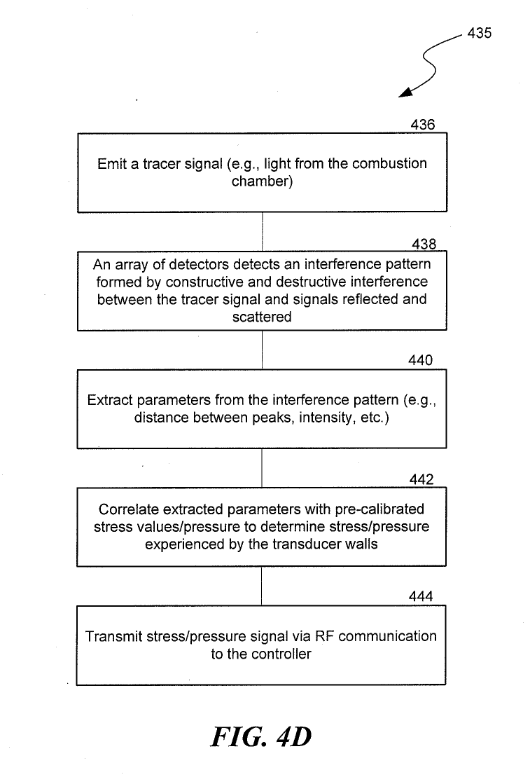

FIG. 4A is a cross-sectional schematic diagram of a pressure or temperature transducer 400 based on a Fabry mirror. The transducer 400 includes a pressure tube having sealed ends. The tube can be made of solid fiber, which has different locations within it that act as partial mirrors or reflectors 405 for reflecting incident light. The pressure tube includes a source or emitter 415 that emits light into the tube and a detector array including one or more photo-detectors for detecting light reflected from the partial mirrors inside the tube. The pressure tube is typically calibrated at ambient pressure. When light is emitted from the source/emitter 415 into the tube, some of the light is reflected off the partial mirrors. The light from the source/emitter 415 can interfere with light that is reflected from the partial mirrors to create an interference pattern that can be detected by the photo-detector array 410.

When the tube experiences an external pressure than exceeds the pressure inside the tube, the walls of the tube can collapse or deform. Using the Poisson effect, and material properties such as modulus of elasticity of the tube fiber, the strain on the tube wall can be determined, and correlated to the pressure acting on the tube wall. Alternately, the deformed or collapsed wall can produce a change in the interference pattern detected by the detector array 410. From the changed interference pattern, the change in pressure (from ambient pressure), or the actual pressure can be determined.

The same transducer 400 can be used to measure temperature. The effects of factors such as pressure may need to be decoupled to determine the temperature more accurately. For example, depending on the coefficient of expansion of the fiber, the tube walls can absorb energy and expand, thereby changing the interference pattern detected at the detector array 410.

In one embodiment, the source or emitter 415 may be one or more light emitting diodes (LEDs). The LEDs may be powered by the energy harvested from events in a combustion chamber, for example. In an alternate embodiment, the source or emitter 415 may be radiation from the combustion chamber. The radiation from the combustion chamber may include different wavelengths of light (e.g., Infrared, visible spectrum, etc.). The spatial resolution of the detector array may depend on the wavelength of radiation from the combustion chamber or the wavelength of the LED light that act as the source/emitter 415.

FIG. 4B illustrates a cross-sectional schematic diagram of a portion of an injector 420 having fibers 425 projecting out of the injector for carrying radiation 430 and/or other information such as temperature, pressure, presence or absence of certain products of combustion, etc., from the combustion chamber to transducer 400 illustrated in FIG. 4A, for example. The fibers 425 allow flexibility in the placement of the dynamic sensors. The actual event data can be read by an optic reader, carried or transported by the optic fibers and distributed to dynamic sensor nodes that are placed outside of the combustion chamber, or away from the source of the event that is to be detected or measured. The fibers 425 may be coated or covered with insulation or other protective material to withstand the high pressure and temperature conditions inside the combustion chamber. For example, in some instances, the fiber head and fiber body may be protected using sapphire bead. In other instances, non-optic fiber structures such as grapheme structures that enable temperature insulation while allowing capture of data can be used.

In one embodiment, the dynamic sensor can be used for monitoring and/or detecting one or more properties of a sample of a target material. For example, the dynamic sensor can be used for collecting a sufficient amount of a target sample, detecting the presence of the portion of the target sample and/or analyzing properties of the target sample, reporting an indication of the detection and/or analysis, and optionally clearing the target sample to enable repeated or cyclic collection of additional samples. Based on one or more factors related to the presence of the target sample or the properties of the target sample, the dynamic sensor can provide an indication of a suitable action or process in response to the detection and/or analysis. A networked array of such dynamic sensors can be used in various suitable environments including, for example, environments directed to quality assurance, preventative maintenance, safety (including trend analysis), hazard warnings (including shut down procedures), chemical identification and surveillance, environmental monitoring, and/or homeland security. The monitoring and/or detecting of one or more properties of a sample of a target material is described in detail in U.S. patent application Ser. No. 13/027,188, filed Feb. 14, 2011, now U.S. Pat. No. 8,312,759, issued Nov. 20, 2012, and entitled “METHODS, DEVICES, AND SYSTEMS FOR DETECTING PROPERTIES OF TARGET SAMPLES” (Attorney Docket No. 69545.8801.US01), and incorporated herein by reference in its entirety.

### Example Placement of Dynamic Sensors

FIG. 4C is a cross-sectional diagram of a system 450 for determining temperature and/or pressure of a combustion chamber, such as those found in heat engines such as gas turbines, rotary combustion engine, and the like configured in accordance with one embodiment of the disclosure.

The system 450 generates ions 490 from fuel and/or constituents of the oxidant in the combustion chamber. Thus ions 490 may be generated from oxygen, nitrogen, water vapor, hydrogen, ammonia, methane, propane, ethane, methanol, ethanol or more complex fuel constituents. The system 450 determines temperature and/or pressure by the ion life and distribution by measuring and characterizing the magnitude, duration and trend of ionic currents between the electrode components of a combined plasma generator and fuel injector 484 and/or the insert sensors 474, 476, 478, 496 and 480 in the thermal dam and power producing and/or cooling inserts 464, 466 and 468 of the combustion chamber such as the head components including intake valve 482, exhaust valve 486, piston 472, and cylinder wall insert 468 in the engine assembly.

In some embodiments additional information including the radiation emissions from such ions and surrounding particles and surfaces are monitored by dynamic sensors having radiation and/or pressure transducers 492, 494, and/or 498 as shown including appropriate counterparts and components in other engines such as gas turbines, and various rotary engines.

In operation, ionizing voltage is delivered to electrodes 460 and 462 through insulated terminal 452 and/or such ionizing events may be powered by suitable high voltage generator such as piezoelectric components 488 within assembly 484 by conversion of pressure energy from the combustion chamber or from a mechanical device such as a cam to produce required strain. In some embodiments, sufficient ionization and/or maintenance of ion populations is aided by the voltage gradient between electrodes 462 or 460 and desired zones of inserts 464, 466, 468, and/or 470 as shown. Information from the dynamic sensors are sent to microprocessor 458 and/or to a computer that is external to assembly 484 for purposes of adaptive operation and control of fuel injection and ignition events. Signals from the dynamic sensors may be reported by suitable wireless frequencies, optical couplings, or by wired connections including various suitable combinations.

In various embodiments, information reported by dynamic sensors can be used for adaptive control. For instance, the reported information can be used to control the operation of the valves (e.g., 482, 486) (i.e., linear engine capability), operation of a tip magnet (not shown) to adjust plasma flow pattern, monitoring of ion flow (e.g., in response to speed of valve opening), monitoring the beginning, duration and end of combustion, and products of combustion, monitoring various conditions to optimize overall engine efficiency, and the like.

FIG. 4D is a flow diagram illustrating an example method 435 for determining and reporting pressure using a dynamic sensor in the system 450 illustrated in FIG. 4C. The method 435 can be implemented, controlled, or otherwise carried out by the dynamic sensor of FIGS. 1 and 2, having a pressure transducer such as that illustrated in FIG. 4A. The dynamic sensor or the pressure transducer may be placed at any of the positions described above with respect to FIG. 4C. The method 435 includes emitting a tracer signal at block 436. The tracer signal may be radiation from the combustion chamber transported or reported by one or more fibers as illustrated in FIG. 4B. Alternately the tracer signal may be generated using on or more LEDs. An array of detectors detects an interference pattern formed by constructive and destructive between the tracer signal and reflected and scattered signals at block 438.

At block 440, the dynamic sensor can extract parameters from the interference pattern, such as distance between peaks or intensities, and the like. At block 442, the extracted parameters are correlated with pre-calibrated values of pressure to determine pressure on the transducer walls. A signal corresponding to the determined pressure value, or an alert is reported via radio frequency communication to a central controller at block 444.

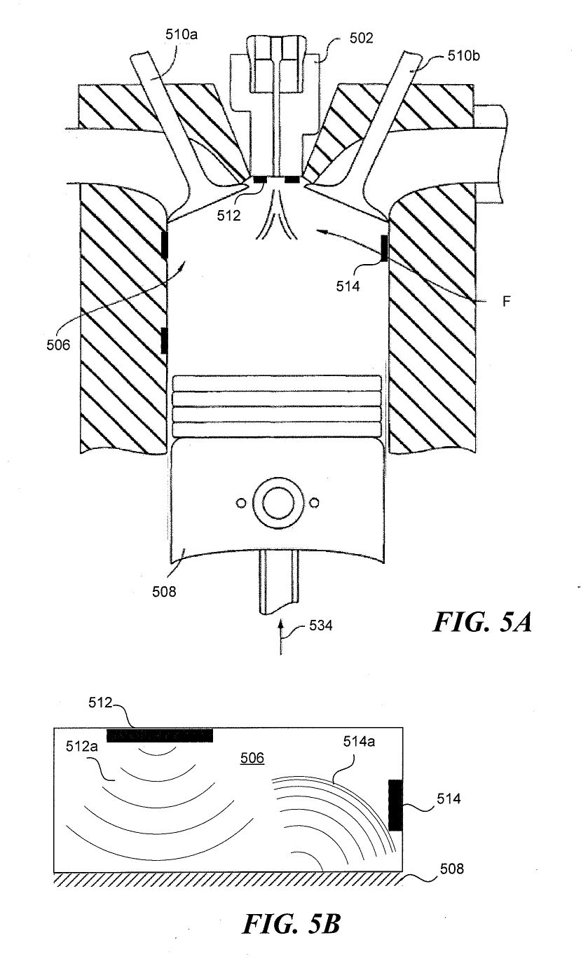

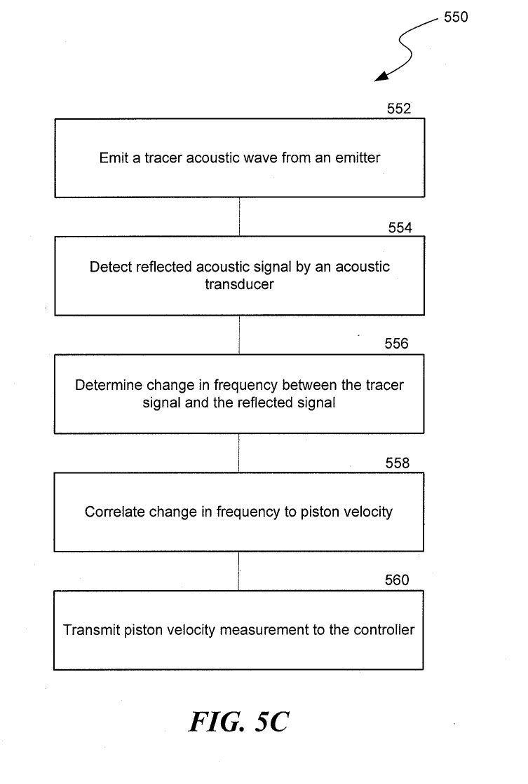

FIG. 5A is a cross-sectional diagram of a system 500 for determining the velocity of a piston inside a combustion chamber, such as those found in heat engines such as gas turbines, rotary combustion engine, and the like configured in accordance with one embodiment of the disclosure. A cross-sectional side view of the combustion chamber 506 is illustrated in FIG. 5A. Distributed inside or near the combustion chamber 506 at locations such as inserts, valves, head of piston, cylinder wall, and the like, are dynamic sensor having emitter such as 512 and one or more detectors such as 514 for measuring the velocity of a piston using Doppler effect.

During the compression portion or compression stroke of the cycle, the valves 510a and 510b are closed and the piston 508 moves in the direction of arrow 534. As the piston 508 moves towards a top dead center, the piston 508 decreases the volume of the combustion chamber 506 and accordingly increases the pressure within the combustion chamber 506. In certain embodiments, during the compression stroke, the injector 502 can dispense fuel F into the combustion chamber 506. For example, during predetermined operating conditions, such as for production of maximum fuel economy, particularly in conjunction with low load or low torque requirements, the injector 502 can dispense the fuel F during the compression stroke of the piston 508. Moreover, the injector 502 can dispense the fuel F in any desired distribution pattern, shape, stratified layers, etc. As such, during the compression stroke the piston 508 can compress the air-fuel mixture as the piston 508 reduces the volume of the chamber 506. In other embodiments, however, the system 500 can operate such that the injector 502 does not introduce fuel F into the combustion chamber 506 during the compression stroke of the piston 508.

One or more dynamic sensors such as 512, 514 are positioned inside or outside the combustion chamber, or on or near the injector, or at any other suitable locations such as those described with respect to FIG. 4C. In some embodiments, the transducer element or sensing element may be positioned inside the combustion chamber, while the rest of the integrated circuit remains outside, and away from the extreme heat and pressure conditions inside the combustion chamber. The dynamic sensors 512 may measure temperature or pressure in the combustion chamber. The dynamic sensors 512 can also measure the velocity of the piston 508, as it moves towards the top dead center or the bottom dead center.

Referring to FIG. 5B, Doppler effect can be used to measure the velocity of the piston. An emitter 512 emits acoustic waves 512a towards the surface of the moving piston 508. The emitter can be controlled using RF, acoustic trigger, piezoelectric trigger, and the like. For example, the emitter 512 can include a micro-antenna or a nano radio that can be energized, interrogated or signaled to emit acoustic waves. In another implementation, the bender or whistler of an injector, that modifies and controls the acoustic characteristic of the plasma and/or fuel emission can be used as a trigger to signal the emitter to emit a tracer signal. In yet another implementation, a piezoelectric component may be used to induce a pressure wave.

As the piston moves in the direction of 534, each successive wave travels a shorter distance to reach the surface of the piston 508 from where it is reflected and the reflected waves 514a are detected by a detector 514 near the source 512. The change in the wavelength or frequency between the waves from the emitter 512 and the detector 514 can be determined by the dynamic sensor, and reported to a central controller or another entity as the velocity of the piston. From velocity, position, and acceleration of the piston can also be determined. The reporting of the information may be, for example, RF controlled, acoustic controlled and/or piezoelectrically controlled.

FIG. 5C is a flow diagram illustrating a method 550 for determining the velocity of a piston in the system 500 illustrated in FIGS. 5A and 5B. An emitter (which can be a part of the dynamic sensor) can emit a tracer signal of a known frequency towards a surface of the piston at block 552. The emitter can be an element that is placed inside or near the combustion chamber to emit or launch acoustic waves. Alternately, sound from the injection of the fuel or any other event in the combustion chamber can be used as a tracer signal that establishes the baseline.

The acoustic waves that are reflected from the surface of the moving piston are detected by an acoustic transducer or detector array at block 554. The dynamic sensor can then determine the change in frequency between the acoustic wave that was emitted and the acoustic wave that was detected at block 556. The change in frequency can then be correlated with piston velocity at block 558. The correlation may be based on calibration data or other reference that can be stored in the memory of the dynamic sensor, for example. The determined piston velocity may be reported to a center controller or other dynamic sensor nodes at block 560. Alternately, the determined piston velocity may also be compared with a threshold range, for example, and when the piston velocity is outside of the range, an alert signal may be transmitted using RF communication to other nodes, a central controller, or directly to a component that controls the speed of the piston.

Dynamic Sensors with Radio Frequency (RF) Control

Radio interference and circuit component damages can occur due to solar flares or various anthropological mishaps or purposes including potential terrorism. Most of the existing transportation system and countless distributed energy applications could be disabled by electromagnetic radiation such as may be caused by a nuclear detonation and ionization of the atmosphere and other radio frequency radiation including solar flares of magnitudes. This is because of the transition to modern electronic control systems which use natural gas, liquid petroleum gases, diesel, and gasoline fueled engines, and can be susceptible to radio frequency damage.

Embodiments that utilize a microcontroller and a suitable actuator such as piezoelectric or a solenoid type driver assembly of coil and an armature may utilize the magnetic circuit provided within a radio frequency (RF) shielding enclosure. Such RF shielding enclosure can prevent externally sourced electromagnetic and other damaging radiation from harming electronics including semiconductor instrumentation and control components incorporated as circuit components of integrated Spark Injector or Smart Plug systems in one implementation. In a further implementation, the RF shielding enclosure can prevent unwanted cross communication between the Spark Injector or Smart Plug systems due to RF interference. In a further implementation, the RF shielding enclosure can prevent RF signals from Spark Injector or Smart Plug system components from causing interference to radios, televisions, and other appliances that are susceptible to such RF interference.

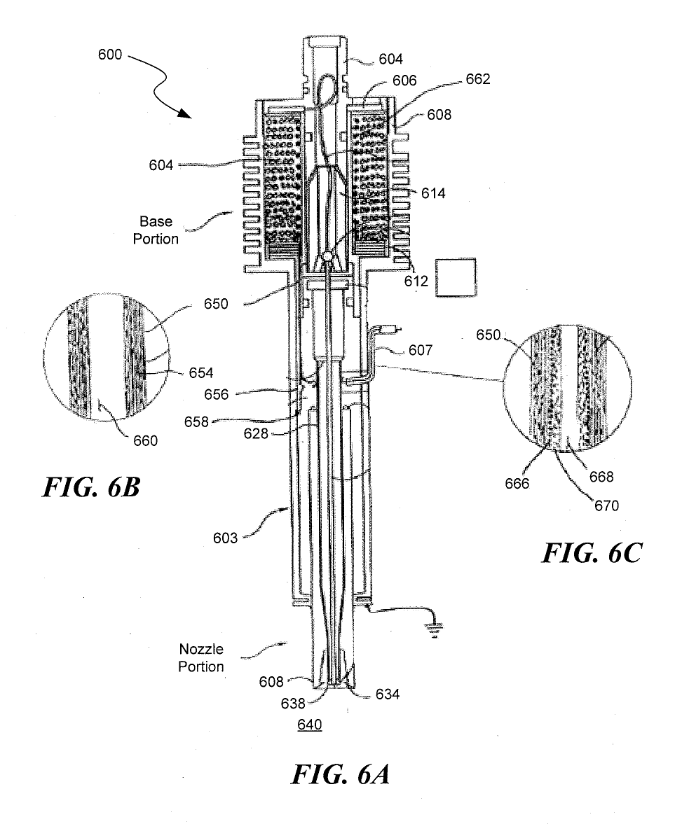

FIG. 6A is a cross-sectional side view of a Spark Injector or Smart Plug with RF shielding. A solenoid winding may be incorporated in a circuit to serve as an electromagnet for operation of armature and valve actuation and additionally as a transformer such as a pulse transformer, transformer with multiple windings, or autotransformer for generating spark or plasma discharges at the interface to the combustion chamber. In other instances it is desired to provide a solenoid winding comprising multiple insulated conductors for the purpose of increasing the number of turns and current magnitude for greater magnetic circuit strength when energized and to thus develop increased magnetic force and decrease the pull-in time for rapid operation of an actuator. Utilization of materials such as polyimide, polyetherimide, parylene, various modified chemical vapor deposited poly (p-xylene) films, glass ceramics, including micro and nano particles including the dielectric systems disclosed in co-pending U.S. patent application Ser. No. 12/653,085, filed Dec. 7, 2009 and entitled “INTEGRATED FUEL INJECTORS AND IGNITERS AND ASSOCIATED METHODS OF USE AND MANUFACTURE” (Attorney Docket No. 69545-8304.US00), and U.S. patent application Ser. No. 12/841,170, filed Jul. 21, 2010 and entitled “INTEGRATED FUEL INJECTORS AND IGNITERS AND ASSOCIATED METHODS OF USE AND MANUFACTURE” (Attorney Docket No. 69545-8305.US00) to insulate the conductor windings enables voltage transformation whereby the multiple windings are energized for very rapid pull in, and at least one winding portion is then switched to serve as the secondary of a transformer circuit to provide the turns ratio and induction desired for the spark or plasma developed at the combustion chamber interface for ignition.

As illustrated in FIG. 6A, the winding for solenoid operations may utilize two or more insulated conductor windings such as 662 and 604 one of which such as 604 becomes the secondary component of a transformer circuit, which may include one or more capacitors 612, that is developed according to switching by a suitable switch or solid state relay depicted at 656 as controlled to develop the spark or plasma when desired.

Although it is illustrated near conductive tube 628, the location of relay 656 could be at other locations such as proximate to the inside of case 608 and winding 604 or a battery or capacitor 612. Secondary 604 is connected by conductive cable 660 to conductive tube or plating 628 and to relay 656 as shown. In operation relay 656 is closed to provide current through winding 604 and conductor 660 of cable 650 to ground connection 658 on case 603 until desired generation of spark or plasma generation between electrodes 628 and 634 at the interface with valve 640 as shown. When relay 656 opens the low impedance current path to ground, the voltage builds to generate the desired spark of plasma discharge in the gap at electrode 628, 638 to electrode 634 as shown. Similarly, the winding for solenoid operations may have three windings that operate as a solenoid coil until one winding is connected in series with another to serve as a secondary circuit and is electrically separated from the remaining winding which serves as the primary. Similarly, the winding for solenoid operations may have four or more windings that operate as a solenoid coil until one winding is used as the primary and the remaining windings are electrically separated and connected in series to form the secondary for spark voltage generation.

In applications such as engines with extended-life duty cycles, plasma voltage generated by one Spark Injector may be applied to one or more other Spark Injectors through cable such as 607 to provide a redundant source for assured spark generation. As depicted in FIG. 6C, cable 607 may be comprised of a solid or tubular ferrite core 668 with a helical winding 666 over a small diameter high magnetic permeability conductor such as a nickel-iron alloy or compacted ferrite particle layer 670 over defining fibers such as glass, carbon, polyimide, polyamidimide, or polyester. Over the resulting high permeability core, a single start or multiple start helical conductor(s) 666 such as 100 or more turns/inch of 0.002″ to 0.004″ diameter conductor such as stainless steel wire is wound. This assembly may then be further insulated with coaxial or wrapped layers to achieve the same benefits of the system disclosed in accordance with FIG. 6B which may include barrier layers or particles 654 for providing favorable lateral charge distribution but effectively preventing radial passage of charge. Resulting inductance values of 100 to 600 micro-Henries per foot for cable 607 enables operation without RF interference or escape in applications on the inside and or outside of Spark Injector systems such as assembly 600 as shown in FIG. 6A. Cable 650 may be similarly composited to provide adequate inductance to confine RF within the cable during operations as described. Cable 607 may be covered with a conductive coating such as a sputtered layer of aluminum in portions extending from the Spark Injector to block external RF radiation.

Effective development of the full potential of multiple layers of insulator material with high dielectric strength depends upon prevention or removal of impurities such as air, water, fingerprints, dust, etc., that typically deposit oligomers and various salts. Illustratively a spiral wound polyimide without such impurities can provide more than 7,000 Volts per layer or winding of film that is 0.001″ thick. Further improvement of dielectric containment of voltage may be provided by incorporation of anisotropic ion migration barrier particles or thin films on the base film such as polyimide polymer. Thus 60,000 volts can be delivered by the secondary with only six to eight turns of wrapped or coaxial layers of such composited impurity-free insulation. In production such insulation may be applied in one or more applications by physical or chemical vapor deposition, compression molding, injection molding, extrusion, calendaring, varnishing, or casting and separate layers may be incorporated with dissimilar materials including various ceramics and glass-ceramics as particles or films including depositions that provide oriented crystallization.

Micro and nano crystals along with deposited layers selected to provide charge migration barriers include alumina, magnesia, quartz, mica, various titanates such as barium titanate, ZnO and such crystal selections may be encapsulated in condensation polymers such as thin piezoelectric polyvinylidene fluoride films. Similarly full or partial encapsulation may be by non-piezoelectric polyolefin, or poly (p-xylene) films. Procedures for impurity free developments of the required insulation values are similar to those employed for semiconductor manufacturing and include production in clean room or clean chamber equipment. Thus the steps include production and maintenance of high purity materials and feed stocks such as semiconductor grade, constant prevention of contaminants from being admitted to the production stage, and completion of the insulation system by drying to remove moisture or elevating the temperature sufficiently to remove moisture and removing air by suitably pressing or vacuum sealing the resulting component(s) against invasion by contaminants. This requires purity assurance instrumentation to detect and prevent virtually every aspect of contamination.

Thin layers 650 of polymer, ceramic or glass-ceramics with nano-sized crystal precipitates or deposits 654 that are oriented parallel to conductor 660 as shown in FIG. 6B provide marked improvement of overall dielectric strength. Fluorapatite mullite, spinel glass-ceramics, and fluoromica glass-ceramics are examples of thin sputtered glass coatings that can be laser heat treated to precipitate crystals of the desired size, orientation and spacing. Coating methods include strictly physical processes such as, but not limited to: plasma bombardment sputtering, cathodic arc deposition, high temperature vacuum evaporation including electron beam and various pulsed laser heating provisions, along with processes that react selected reagents to produce chemical vapor deposition including nano particles and nucleation agents for inducing crystal formation.

In applications where it is desirable to utilize a more rapid operator to control valves such as 638, including instances of various combinations with a fuel distributor, armature 614 may be provided with or as a piezoelectric component in a suitably connected electrical circuit with one or more inductive windings such as 604 and 662. This provides efficient close coupling of the transformer and/or capacitor 612 to the piezoelectric driver and provides prevention of RF transmission to or from the integrated Spark Injector or Smart Plug.

Rapid cycling of the fuel control valve is facilitated as may be desired by high-speed action of the piezoelectric driver and spark or plasma generation is provided by the circuit controlled by relay 656 to adaptively optimize fuel efficiency and prevention of emissions including oxides of nitrogen, carbon monoxide, and hydrocarbons. In some applications it is desirable to utilize the inductive energy from another Spark Injector system as may be delivered by cable such as 607 to provide one or more spark or plasma discharges and/or to provide one or more piezoelectric valve drive operations. In instances that armature 614 is provided as a combination of an electromagnetic and piezoelectric driver, various modes of operation are enabled including longer motion by the electromagnetic element and shorter and potentially faster motions by the piezoelectric element to produce commensurately proportioned and conditioned fuel flow timing and rates from the fuel control valve such as 638 that is chosen for various optimized applications. This provides new optimization parameters for controlling fuel penetration into air in the combustion chamber including control of surface to volume characteristics, air insulation pattern, combustion rates, combustion pattern, combustion characterization, and air utilization efficiency.

In illustrative combined fuel-injection and spark-ignition operation in application on a heat engine, a relatively small amount of the thermal and pressure energy produced in the combustion chamber of the engine may be converted by one or more generators such as piezoelectric, photo voltaic, and or thermoelectric devices and delivered for storage in a battery, reversible fuel cell, or capacitor 612. Such stored energy may power micro-computer 606 and armature 614 which may be an appropriate actuator component of an electromagnetic, piezoelectric, pneumatic, hydraulic, combined pneumatic and hydraulic, or combined electromagnetic and piezoelectric circuit. Control including adaptive response to operation requirements and data derived by sensing of pressure, temperature, and dynamic combustion characteristics of the heat engine along with conditioning and switching of electric current at appropriate voltage for such purposes may be provided by a circuit including appropriate relays and an effective transformer, solenoid, or combined solenoid and transformer such as 662 and 604.

Utilization of direct conversion generators including piezoelectric, photovoltaic, and or thermoelectric devices to harvest a relatively minute amount of ordinarily wasted energy that is released in the engine's combustion chamber greatly improves the overall energy conversion efficiency of vehicular and distributed power applications compared to requiring the engine to produce shaft power that is mechanically conveyed to an alternator that electrically conveys energy to a battery that supplies electricity for Spark Injector operations. This is because generation and delivery of energy from the engine's output shaft, at best, incurs a loss of 50% or more from the energy available in the combustion chamber which is diminished by further losses to drive and operate an alternator that incurs losses that may vary from about 20 to 80% depending upon the engine speed and condition of the lead-acid storage battery and is further diminished by various circuit losses required to deliver energy needed for fuel-injection and spark-ignition operations.

The resulting Spark Injector or Smart Plug embodiment including versions that provide energy conversion operations is less expensive to produce, more efficient in operation, and more reliable as a comprehensive integrated system than conventional systems that have separately packaged components such as a distributor, coil, spark plug, and fuel injector. In operation the comprehensive system is able to withstand RF magnitudes that disable conventional electronically controlled fuel injection and ignition systems. Preventing and or containing RF radiation within the integrated package enables much more efficient low resistance conveyance of plasma or spark energy from the transformer coil to the ignition gap because it is not necessary to utilize conventional high resistance spark plug cable of considerably longer length. Energy is delivered to the spark or plasma that is ordinarily dissipated due to impedance losses to minimize radio frequency radiation that would escape from low resistance spark plug cable.

In applications such as 100 mpg family cars, 200 mpg sub-compact vehicles, and 600 mpg motorcycles Spark Injectors enable far more efficient engine operation to provide propulsion with much greater overall fuel efficiency than conventional combinations that include an engine along with an alternator and battery as separate devices. This facilitates a much more efficient conversion of kinetic energy as a vehicle is slowed or stopped by a driveline generator that delivers energy to the reversible electrolyzer disclosed in U.S. patent application Ser. No. 12/707,651, filed Feb. 17, 2010 (now U.S. Pat. No. 8,075,748, issued Dec. 13, 2011) and entitled “ELECTROLYTIC CELL AND METHOD OF USE THEREOF” (Attorney Docket No. 69545-8101.US01), which is incorporated herein by reference in its entirety.

In heavy trucks and rail locomotive applications conversion of much larger kinetic energy as trains are slowed or stopped by delivery of electricity from the reversible electric drive motors to such electrolyzers. RF damages to electrical equipment due to previous solar flares consequences are sudden, expensive, and may be disabling or debilitating for months. Future damages to transformers and other components of the electric transmission grid and essential appliances including life-support appliances can be prevented by using improved voltage-containment, insulation, multi-functional systems, and RF control systems and technologies disclosed herein. The same principles and embodiments disclosed herein for Spark Injector or Smart Plug applications provide improvements and safeguards for a very wide variety of electrical, electronic, electromechanical, computer, and instrumentation components and systems.

### Dynamic Sensors in Thermochemical Regeneration (TCR) Apparatus

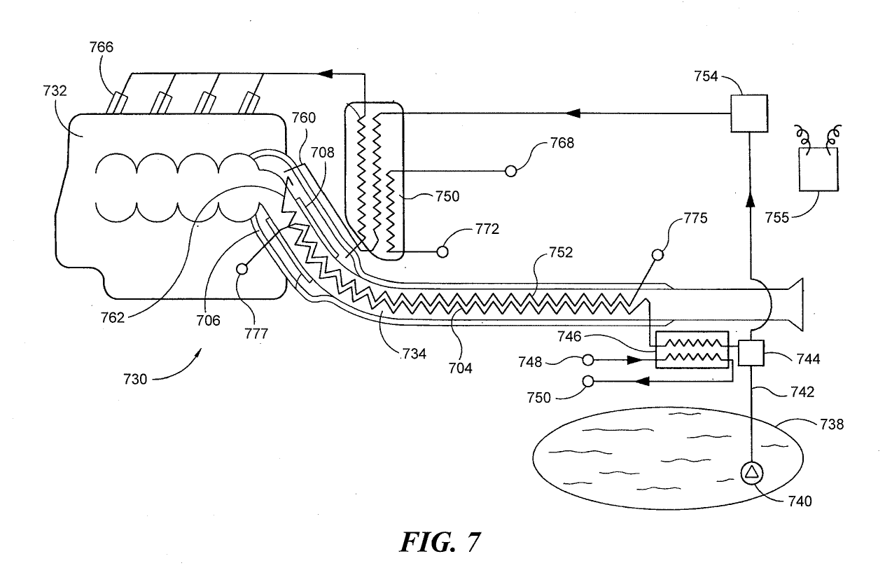

FIG. 7 is a schematic cross-sectional view of a Thermochemical Regeneration (TCR) system 730 having one or more dynamic sensors. Thermochemical regeneration can be used to provide oxygenated fuel to combustion chamber. Thermochemical regeneration processes drive endothermic reactions that provide oxygenated fuel specifies. In addition to providing oxygenated fuel species, thermochemical regeneration processes provide 15% to 30% more fuel value along with hydrogen-characterized fuel combustion characteristics upon combustion compared to the original fuel that is selected for the processes disclosed in the following embodiments.

Hydrogen characterized combustion is seven to ten times faster than hydrocarbons such as methane and therefore enables much more torque to be developed per calorie or BTU of heat released than slower burning fuels that require much earlier ignition and thus cause heat loss and counter-torque losses during the compression period of engine operation.

Equation 701 summarizes the general process for hydrocarbons such as diesel fuel, gasoline, natural gas, propane, ethane, etc.:

HₓC_{y}+yH₂O+HEAT₁→yCO+(y+0.5x)H₂ Equation 701

CH₄+H₂O+HEAT→CO+3H₂ Equation 702

Equation 702 summarizes the production of oxygenated carbon fuel as shown whereby methane is reacted with steam to produce carbon monoxide and hydrogen.

In addition to production of oxygenated fuel species from hydrocarbons, another embodiment produces oxygenated fuel species from low cost fuels such as mixtures of alcohol, water and a carbon donor. Equation 703 summarizes the process for an alcohol such as butanol and a carbon donor, for example, a colloidal or otherwise suspended substance containing carbon, such as a cellulose, sugar, starch, fat or protein from a waste source.

C₄H₉OH+4H₂O+C+HEAT₃→5CO+9H₂ Equation 702

Referring to FIG. 7, the thermochemical regeneration system 730 is utilized with a heat engine 732. The heat engine 732 provides heat from an engine coolant circuit that includes priority delivery of heat by a controller 755 through a “hot” connection or inlet 748. A cooler return 750 delivers coolant for subsequent heat rejection by a suitable system such as an air cooled radiator (not shown). This serves the purpose of preheating fuel delivered from a sufficiently pressurized tank source 738 or through pump 740 into line 742 and through valve 744 to heat exchanger 746 as shown. According to further aspects of the disclosure, preheated fuel may then be routed to another countercurrent heat exchanger 704 for heating such fuel by heat transfer from exhaust gases 734. According to one embodiment, the exhaust gases 734 may be routed through tubing 762 to reaction zone 706 for the carbon oxygenation process to produce fully oxygenated carbon monoxide along with hydrogen as summarized by Equation 701.

Alternative configurations, as one skilled in the art would understand, are within the scope of the disclosure. Hot steam from the exhaust stream passes across membrane 708 for supplying or supplementing other sources of water utilized in Equation 701. According to further aspects of the disclosure, regenerative energy as may be provided by energy harvesting operations such as regenerative braking or harvesting of combustion chamber energy sources including vibration, radiation, and pressure may be delivered to the tubular heat exchanger 704 by a suitable inductive or resistance heater 752 by connections 775, 777 as shown.

Considerable thermal banking or retention of such heat in surplus of the amount consumed by the endothermic process of Equations 701, 702 or 703 may be provided by material selections such as graphite or boron nitride. Alternatively or additionally, a change of phase heat exchanger and storage capability may be provided by substances such as salt compositions that change phase at a desired temperature such as at or above the temperature required for processes such as shown in Equations 701, 702 and 703. Such thermal banking materials and/or phase change storage may be provided in the those shown in Equations 700, 702, and 703 are thus heated to adequate temperature for the reactions indicated and delivered to reaction zone 708 and 706 by insulated tubing 762 as shown.

The stream of hot fuel constituents such as hydrogen and carbon monoxide produced by reactions shown in Equations 701, 702 and 703, is cooled by counter current heat exchange with fuel from the tank 738. An optimization controller 755 controls fuel delivery through control valves 744 and 754. Accordingly, in operation, the fuel from tank 738 is heated to approximately the temperature of the products from the reactor 706, while the stream of hydrogen and carbon monoxide is cooled to nearly the temperature of fuel from tank 738.

This thermochemical regeneration system provides hydrogen-characterized fuel with superior heat removal capabilities for circulation within desired spaces and places for cooling one or more fuel injection valves 766, which in turn control direct fuel injection into the combustion chambers of the engine 732. A resistance or inductive heater 770 with connections 768, 772 may be utilized to further apply heat which has been generated from energy harvesting operations to increase the temperature of fuel delivered by insulated tubing 760 to reaction zone 706. The thermochemical regeneration processes are described in further detail in U.S. patent application Ser. No. 12/804,509, filed Jul. 21, 2010 and entitled “METHOD AND SYSTEM OF THERMOCHEMICAL REGENERATION TO PROVIDE OXYGENATED FUEL FOR EXAMPLE, WITH FUEL-COOLED INJECTORS” (Attorney Docket No. 69545-8310), which is incorporated herein by reference in its entirety.

In one embodiment, the dynamic sensor used in the thermochemical regeneration system illustrated in FIG. 7 can be configured as a chemical species detector that detects constituents of fuel such as methane. For example, presence and/or concentration of a constituent such as methane in injected fuel may be provided through a range of thermochemical regeneration operation, from start up to steady state to shut down for processes shown in Equations 702 (above) and 704 shown below:

CH₄+H₂O+HEAT→CO+2H₂+CH₄+H₂O Equation 702

In one implementation, the dynamic sensor can include a tunable laser that produces a light beam having a wavelength that corresponds to the absorption band of a chemical species for illuminating a combustion chamber. When a targeted chemical species is present in the combustion chamber, the molecules of the target chemical species absorb some of the energy and an attenuated laser beam (or reflected and attenuated laser beam) hits a detector in the dynamic sensor. Alternately, the process described in U.S. Pat. No. 7,075,653 and/or the references cited in the patent may be used for detecting a chemical species using the dynamic sensor. The dynamic sensor capable of detecting chemical specifies can be attached to one or more fiber optic connected and/or integrated monitors in the Spark Injector to detect a chemical species such as methane. Detection of methane, for example, allows for adaptive optimization of the thermochemical regeneration process, injection pressure, ionization timing, turbocharger management, and the like. In some instances, the status of the thermochemical regeneration process may be monitored along with other injection and combustion processes to ensure emission free operations. In some instances, in addition to methane detection, a number of other constituents such as ozone (O3), radicals such as methyl (CH3), methylene (CH2), carbyne (CH), nitrous oxide (N2O), nitrogen monoxide (NO), nitrogen dioxide (NO2), along with the occurrence of any carbon-rich particles can be detected by the dynamic sensor by tuning the light or laser beam to a particular wavelength.

In some embodiments, designer fuels that may include one or more fuel additives or chemical tracers (e.g., gas crystal) that emit radiation having a wave length or a wave length pattern that is specific to combustion chamber conditions such as temperature, pressure, products of combustion, and the like may be used. The dynamic sensor can then detect the emitted wave length or pattern triggered by an event in the combustion chamber.

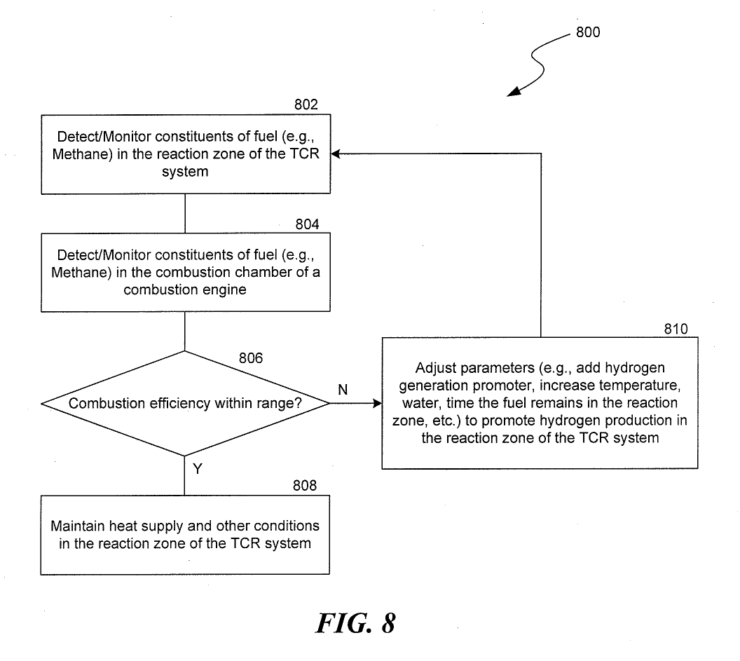

FIG. 8 is a flow diagram illustrating a method 800 of using a dynamic sensor in the TCR apparatus illustrated in FIG. 7 for optimizing combustion efficiency.

One or more dynamic sensors located in the reaction zone or proximate to the reaction zone of the TCR apparatus can monitor conditions such as temperature and/or pressure in the reaction zone at block 802. In one implementation, dynamic sensors for detecting and/or monitoring constituents of fuel such as hydrogen, carbon monoxide, and/or a feed stock such as propane, ammonia, urea, or methane may also be located in the reaction zone or proximate to the reaction zone. At block 804, constituents of fuel and/or conditions in the combustion chamber of a combustion engine may be detected and/or monitored. Alternately, signals corresponding to the detected constituent of the fuel and/or detected conditions in the combustion chamber may be received. At decision block 806, if the combustion efficiency within a desired or predefined range, the conditions in the reaction zone may be maintained at block 808. For example, the heat supply to the reaction zone may be maintained. Alternately, if the combustion efficiency is outside of the range, one or more parameters may be adjusted at block 810 to bring the efficiency of the combustion process within a desired range. The combustion efficiency may be determined or gauged from various information such as the methane level, temperature, pressure, acoustic signature, and the like in the combustion chamber.

The following examples are illustrative of several embodiments of the disclosed dynamic sensors.
1. A dynamic sensor for sensing conditions in a combustion engine, comprising:
   a transducer located inside or outside a combustion chamber of a combustion engine for detecting a condition inside the combustion chamber and generating one or more detected signals;
   a controller for receiving and processing the one or more detected signals to generate an output signal for controlling one or more conditions inside the combustion chamber;
   a transceiver for reporting the output signal;
   a memory for storing instructions and calibration data; and
   an energy harvester for harvesting energy from events in the combustion chamber to power at least one of the transducer, the controller, the transceiver and the memory.
2. The dynamic sensor of example 1, wherein the transducer is disposed on or near an intake valve, an exhaust valve, a piston or a cylinder wall of the combustion engine.
3. The dynamic sensor of example 1, wherein the transducer is located inside the combustion chamber and the controller is located outside the combustion chamber.
4. The dynamic sensor of example 1, wherein the transceiver is located in an injector of the combustion engine.
5. The dynamic sensor of example 1, wherein the dynamic sensor is a system on a chip (SoC) integrating the transducer, the controller, the transceiver, the memory and the energy harvester on a single integrated circuit.
6. The dynamic sensor of example 3, wherein the transducer and the controller communicate with each other using optical communication or radio frequency communication.
7. The dynamic sensor of example 1, wherein the transducer includes a pressure or a temperature sensor that comprises:
   a tube having sealed ends,
   a light source disposed inside the tube and an array of photo-detectors adjacent to the light source,
   wherein the tube has a wall that reflects incident light from the light source.
8. The dynamic sensor of example 7, wherein the array of photo-detectors detects an interference pattern formed by constructive and destructive interference between the incident and reflected light, the interference pattern being modulated by pressure exerted on the wall of the tube.
9. The dynamic sensor of example 8, wherein the controller is configured to:
   extract one or more parameters from the interference pattern;
   retrieve pre-calibrated pressure data from the memory; and
   correlate the extracted parameters to the pre-calibrated pressure data to determine pressure exerted on the tube.
10. The dynamic sensor of example 9, wherein the transceiver are configured to: transmit an output signal corresponding to the pressure exerted on the tube.
11. The dynamic sensor of example 7, wherein the light source is selected from a group including: one or more light emitting diodes and radiation generated by combustion event in the combustion chamber, the radiation being transported from the inside of the combustion chamber to the inside of the tube via a fiber optic cable.
12. The dynamic sensor of example 1, wherein the transducer is triggered to detect the condition inside the combustion chamber by at least one of a radio frequency signal or an acoustic signal received by the transceiver.
13. The dynamic sensor of example 1, wherein transceiver is triggered to report the output signal by at least one of a radio frequency signal or an acoustic signal received by the transceiver.
14. The dynamic sensor of example 1, wherein the transducer is triggered to emit an acoustic wave in response to a radio frequency signal received by the transceiver.
15. The dynamic sensor of example 1, wherein the transceiver communicates the one or more detected signals from the transducer to the controller.
16. The dynamic sensor of example 2, wherein the transducer is a velocity sensor that measures the velocity of the piston as it moves inside the combustion chamber, the transducer comprising:
   an emitter that emits an acoustic signal of a known frequency; and
   a detector that detects an acoustic signal reflected from the surface of the piston and the walls of the combustion chamber.
17. The dynamic sensor of example 16, wherein the controller is configured to:
   receive the acoustic signal detected by the detector; determine the velocity of the piston based on the difference in frequency between the emitted acoustic signal and the detected acoustic signal.
18. The dynamic sensor of example 1, wherein the transducer includes an array of detectors for detecting an interference pattern formed by interference between an acoustic signal from an event in the combustion chamber and acoustic signals reflected from surfaces of the combustion chamber.
19. The dynamic sensor of example 18, wherein, the interference pattern is an acoustic signature corresponding to addition of an oxidant to fuel in the combustion chamber.
20. The dynamic sensor of example 18, wherein, the interference pattern is an acoustic signature corresponding to a surplus of air in the combustion chamber.
21. The dynamic sensor of example 18, wherein, the interference pattern is an acoustic signature corresponding to an optimum plasma for injection.
22. The dynamic sensor of example 18, wherein, the interference pattern is an acoustic signature corresponding to production of one or more products of combustion.
23. The dynamic sensor of example 1, wherein the transducer includes a chemical species detector for measuring concentration of the chemical species in the combustion chamber, comprising:
   a tunable laser producing a light beam having a wavelength that corresponds to the absorption band of a chemical species for illuminating the combustion chamber;
   a detector for detecting a portion of the light beam reflected from a surface of the combustion chamber.
24. The dynamic sensor of example 18, wherein the chemical specifies includes at least one of: methane, ozone, hydrocarbons, or particulates.
25. The dynamic sensor of example 1, further configured to detect an emission triggered by an event in the combustion chamber, wherein the emission is from a chemical agent added to fuel.
26. The dynamic sensor of example 1, wherein the energy harvester includes a piezoelectric element and circuitry to produce electrical energy from vibration, pressure or acoustic waves generated by combustion events.
27. The dynamic sensor of example 1, wherein the energy harvester includes a photovoltaic element and circuitry to produce electricity from radiation generated by combustion events.
28. The dynamic sensor of example 1, wherein the energy harvester includes a thermoelectric element and interface circuitry to produce electricity from temperature difference generated by combustion events.
29. The dynamic sensor of example 1, wherein.
   the memory includes data on a range of temperatures or pressures for the combustion chamber in operation,
   the transducer measures temperature or pressure inside the combustion chamber, and
   the controller compares the measured temperature or pressure to the range of temperatures or pressures to determine:
   if the measured temperature or pressure is outside of the range of temperatures or pressures,
   and if so, send a radio frequency signal to a central controller to report the measured temperature or pressure being outside of the range of temperatures.
30. A dynamic sensor for sensing conditions in a thermochemical regeneration (TCR) apparatus, comprising:
   a transducer located at or near a reaction zone of the TCR apparatus for detecting one or more constituents of fuel in the reaction zone and generating one or more detected signals;
   a controller for receiving and processing the one or more detected signals to generate an output signal for promoting production of oxygenated carbon fuel in reaction zone for injection in a combustion chamber;
   a transceiver for reporting the output signal;
   a memory for storing instructions and calibration data; and
   an energy harvester for harvesting energy from vibration, temperature or light to power at least one of the transducer, the controller, the transceiver and the memory.
31. The dynamic sensor of example 30, wherein the one or more constituents of fuel include methane or carbon monoxide.
32. The dynamic sensor of example 30, wherein the output signal for promoting production of oxygenated carbon fuel in reaction zone for injection in the combustion chamber controls the supply of steam to the reaction zone via capillaries.
33. The dynamic sensor of example 30, wherein the output signal for promoting production of oxygenated carbon fuel in reaction zone for injection in the combustion chamber controls the heating of the fuel in the reaction zone via heat supplied by the energy harvester.
34. A method for sensing conditions in a combustion engine, comprising:
   detecting a condition inside a combustion chamber using a transducer located inside or outside the combustion chamber of a combustion engine and generating one or more detected signals;
   receiving and processing the one or more detected signals using a controller to generate an output signal for controlling one or more conditions inside the combustion chamber;
   reporting the output signal via a transceiver;
   storing instructions and calibration data in a memory; and
   harvesting energy from events in the combustion chamber to power at least one of the transducer, the controller, the transceiver and the memory.
35. A method for sensing conditions in a thermochemical regeneration (TCR) apparatus, comprising:
   detecting one or more constituents of fuel in a reaction zone of the TCR apparatus using a transducer located at or near the reaction zone and generating one or more detected signals;
   receiving and processing the one or more detected signals using a controller to generate an output signal for promoting production of oxygenated carbon fuel in reaction zone for injection in a combustion chamber;
   reporting the output signal via a transceiver;
   storing instructions and calibration data in a memory; and
   harvesting energy from vibration, temperature or light to power at least one of the transducer, the controller, the transceiver and the memory.

### CONCLUSION

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number, respectively. When the claims use the word “or” in reference to a list of two or more items, that word covers all of the following interpretations of the word: any of the items in the list, all of the items in the list, and any combination of the items in the list.

From the foregoing, it will be appreciated that specific embodiments of the invention have been described herein for purposes of illustration, but that various modifications may be made without deviating from the spirit and scope of the invention. Accordingly, the invention is not limited except as by the appended claims.

I claim:

1. A dynamic sensor for sensing conditions in a combustion engine, comprising:
a transducer located inside or outside a combustion chamber of a combustion engine for detecting a condition inside the combustion chamber and generating one or more detected signals;
a controller for receiving and processing the one or more detected signals to generate an output signal for controlling one or more conditions inside the combustion chamber;
a transceiver for reporting the output signal;
a memory for storing instructions and calibration data; and
an energy harvester for harvesting energy from events in the combustion chamber to power at least one of the transducer, the controller, the transceiver and the memory.

2. The dynamic sensor of claim 1, wherein the transducer is disposed on or near an intake valve, an exhaust valve, a piston or a cylinder wall of the combustion engine.

3. The dynamic sensor of claim 1, wherein the transducer is located inside the combustion chamber and the controller is located outside the combustion chamber.

4. The dynamic sensor of claim 1, wherein the transceiver is located in an injector of the combustion engine.

5. The dynamic sensor of claim 1, wherein the dynamic sensor is a system on a chip (SoC) integrating the transducer, the controller, the transceiver, the memory and the energy harvester on a single integrated circuit.

6. The dynamic sensor of claim 3, wherein the transducer and the controller communicate with each other using optical communication or radio frequency communication.

7. The dynamic sensor of claim 1, wherein the transducer includes a pressure or a temperature sensor that comprises:
a tube having sealed ends,
a light source disposed inside the tube and an array of photo-detectors adjacent to the light source,
wherein the tube has a wall that reflects incident light from the light source.

8. The dynamic sensor of claim 7, wherein the array of photo-detectors detects an interference pattern formed by constructive and destructive interference between the incident and reflected light, the interference pattern being modulated by pressure exerted on the wall of the tube.

9. The dynamic sensor of claim 8, wherein the controller is configured to:
extract one or more parameters from the interference pattern;
retrieve pre-calibrated pressure data from the memory; and
correlate the extracted parameters to the pre-calibrated pressure data to determine pressure exerted on the tube.

10. The dynamic sensor of claim 9, wherein the transceiver are configured to:
transmit an output signal corresponding to the pressure exerted on the tube.

11. The dynamic sensor of claim 7, wherein the light source is selected from a group including: one or more light emitting diodes and radiation generated by combustion event in the combustion chamber, the radiation being transported from the inside of the combustion chamber to the inside of the tube via a fiber optic cable.

12. The dynamic sensor of claim 1, wherein the transducer is triggered to detect the condition inside the combustion chamber by at least one of a radio frequency signal or an acoustic signal received by the transceiver.

13. The dynamic sensor of claim 1, wherein transceiver is triggered to report the output signal by at least one of a radio frequency signal or an acoustic signal received by the transceiver.

14. The dynamic sensor of claim 1, wherein the transducer is triggered to emit an acoustic wave in response to a radio frequency signal received by the transceiver.

15. The dynamic sensor of claim 1, wherein the transceiver communicates the one or more detected signals from the transducer to the controller.

16. The dynamic sensor of claim 2, wherein the transducer is a velocity sensor that measures the velocity of the piston as it moves inside the combustion chamber, the transducer comprising:
an emitter that emits an acoustic signal of a known frequency; and
a detector that detects an acoustic signal reflected from the surface of the piston and the walls of the combustion chamber.

17. The dynamic sensor of claim 16, wherein the controller is configured to:
receive the acoustic signal detected by the detector;
determine the velocity of the piston based on the difference in frequency between the emitted acoustic signal and the detected acoustic signal.

18. The dynamic sensor of claim 1, wherein the transducer includes an array of detectors for detecting an interference pattern formed by interference between an acoustic signal from an event in the combustion chamber and acoustic signals reflected from surfaces of the combustion chamber.

19. The dynamic sensor of claim 18, wherein, the interference pattern is an acoustic signature corresponding to addition of an oxidant to fuel in the combustion chamber.

20. The dynamic sensor of claim 18, wherein, the interference pattern is an acoustic signature corresponding to a surplus of air in the combustion chamber.

21. The dynamic sensor of claim 18, wherein, the interference pattern is an acoustic signature corresponding to an optimum plasma for injection.

22. The dynamic sensor of claim 18, wherein, the interference pattern is an acoustic signature corresponding to production of one or more products of combustion.

23. The dynamic sensor of claim 1, wherein the transducer includes a chemical species detector for measuring concentration of the chemical species in the combustion chamber, comprising:
a tunable laser producing a light beam having a wavelength that corresponds to the absorption band of a chemical species for illuminating the combustion chamber;
a detector for detecting a portion of the light beam reflected from a surface of the combustion chamber.

24. The dynamic sensor of claim 18, wherein the chemical specifies includes at least one of: methane, ozone, hydrocarbons, or particulates.

25. The dynamic sensor of claim 1, further configured to detect an emission triggered by an event in the combustion chamber, wherein the emission is from a chemical agent added to fuel.

26. The dynamic sensor of claim 1, wherein the energy harvester includes a piezoelectric element and circuitry to produce electrical energy from vibration, pressure or acoustic waves generated by combustion events.

27. The dynamic sensor of claim 1, wherein the energy harvester includes a photovoltaic element and circuitry to produce electricity from radiation generated by combustion events.

28. The dynamic sensor of claim 1, wherein the energy harvester includes a thermoelectric element and interface circuitry to produce electricity from temperature difference generated by combustion events.

29. The dynamic sensor of claim 1, wherein:
the memory includes data on a range of temperatures or pressures for the combustion chamber in operation,
the transducer measures temperature or pressure inside the combustion chamber, and
the controller compares the measured temperature or pressure to the range of temperatures or pressures to determine:
if the measured temperature or pressure is outside of the range of temperatures or pressures,
and if so, send a radio frequency signal to a central controller to report the measured temperature or pressure being outside of the range of temperatures.

30. A dynamic sensor for sensing conditions in a thermochemical regeneration (TCR) apparatus, comprising:
a transducer located at or near a reaction zone of the TCR apparatus for detecting one or more constituents of fuel in the reaction zone and generating one or more detected signals;
a controller for receiving and processing the one or more detected signals to generate an output signal for promoting production of oxygenated carbon fuel in reaction zone for injection in a combustion chamber;
a transceiver for reporting the output signal;
a memory for storing instructions and calibration data; and
an energy harvester for harvesting energy from vibration, temperature or light to power at least one of the transducer, the controller, the transceiver and the memory.

31. The dynamic sensor of claim 30, wherein the one or more constituents of fuel include methane or carbon monoxide.

32. The dynamic sensor of claim 30, wherein the output signal for promoting production of oxygenated carbon fuel in reaction zone for injection in the combustion chamber controls the supply of steam to the reaction zone via capillaries.

33. The dynamic sensor of claim 30, wherein the output signal for promoting production of oxygenated carbon fuel in reaction zone for injection in the combustion chamber controls the heating of the fuel in the reaction zone via heat supplied by the energy harvester.
